(19) United States
(12) Patent Application Publication
(10) Pub. No.: US 2014/0225910 A1
(43) Pub. Date: Aug. 14, 2014

(54) METHODS AND APPARATUS TO RENDER COLORS TO A BINARY HIGH-DIMENSIONAL OUTPUT DEVICE

(71) Applicant: QUALCOMM INCORPORTED, San Diego, CA (US)

(72) Inventors: Huanzhao ZENG, San Diego, CA (US); Jian J. MA, San Diego, CA (US); John H. HONG, San Clemente, CA (US); Chong U. LEE, San Diego, CA (US)

(73) Assignee: QUALCOMM INCORPORATED, San Diego, CA (US)

(21) Appl. No.: 13/766,430

(22) Filed: Feb. 13, 2013

(51) Int. Cl. G09G 5/06

(52) U.S. Cl. CPC G09G 5/06
USPC 345/591

(57) ABSTRACT

Disclosed are methods and apparatus for color rendering in a binary high-dimensional output device, for example. The methods and apparatus are configured to receive color space data, and then map the received data to an intermediate color space. From this intermediated space, color rendering is performed using a pre-generated number of extended primary colors for temporal modulation. Each of the pre-generated extended primary colors is made up of a combination of at least two subframes with each subframe having a respective primary color. Through use of temporally modulated, pre-generated extended primaries in the color space, the methods and apparatus afford a reduction in the diffusion error for subsequent neighboring pixels yet to be rendered, particularly when using constrained devices such as binary high-dimensional output devices.

### BACKGROUND

1. Field

The present disclosure relates generally to color rendering to an output device, and more specifically to methods and apparatus for color rendering for output to display devices, such as binary, high-dimensional output display devices.

2. Background

For display devices, in order to produce intended colors that will be displayed on a target display device, normally a source color (e.g. source color space expressed as a tuple of numbers in standard RGB (sRGB)) must be converted to a color space of the target device (e.g. the device RGB of an LCD display, for example, or the device CMYK of a printer). This can be a computationally intensive process due to sophisticated algorithms applied for gamut mapping, color separation, etc. The most direct way of getting from a source to a destination device color space is to set up a direct transformation, such as through a look-up table (LUT) where destination color values are stored for a regular sampling of the source color space. To convert colors fast enough for practical applications, the color conversion is typically pre-computed offline and stored in the LUT. A color in the source color space is then transformed to the target device color space in real time using the pre-computed LUT.

A known approach is to compute a LUT that contains all of the combinations of the source colors. For example, in an 8-bit/channel sRGB color space, a LUT that contains 256×256×256 nodes must be produced for this purpose (since the color space is 3 dimensional). Due to practical hardware limitations, especially in mobile devices, it is known to utilize a much smaller LUT computed from the full 256×256×256 LUT, for example, and a real-time interpolation process is then applied in conjunction with the smaller LUT to transform colors from the input color space to the output color space.

Even with a reduced size LUT, however, in certain display devices, such a binary high-dimensional output devices, conventional interpolation methods do not work. For example, given a standard sRGB color space input, situations arise during interpolation to the device color space for a constrained high-dimensional binary output device (i.e., constrained to three output colors) where conventional interpolation would cause such devices to simultaneously have more than three different pixel color settings in an array of pixels modulating colors, which is not tenable when constrained to three colors to be used for rendering the particular interpolated color. Thus, there is a need for methods and apparatus for color rendering in such devices operating under such color constraints, as well as a reduction in the diffusion error for subsequent neighboring pixels yet to be rendered.

### SUMMARY

The examples described herein provide methods and apparatus for color rendering for display devices that afford a reduction in diffusion error, especially in high-dimensional binary output devices. Thus, according to a first aspect, a method for color rendering is disclosed that includes receiving color space data and mapping this received color space data to an intermediate color space. The method further includes color rendering from the intermediate space using a pre-generated plurality of extended primary colors for temporal modulation, wherein each of the pre-generated plurality of extended primary colors comprises a combination of at least two subframes with each subframe having a respective primary color.

According to another aspect, an apparatus is disclosed for color rendering including means for receiving color space data, and means for mapping the received color space data to an intermediate color space. The disclosed apparatus also includes means for color rendering from the intermediate space using a pre-generated plurality of extended primary colors for temporal modulation, wherein each of the pre-generated plurality of extended primary colors comprises a combination of at least two subframes with each subframe having a respective primary color.

According to yet another aspect, an apparatus for color rendering is disclosed having at least one processor configured to receive color space data, and map the received color space data to an intermediate color space. The at least one processor is also configured to color render from the intermediate space using a pre-generated plurality of extended primary colors for temporal modulation, wherein each of the pre-generated plurality of extended primary colors comprises a combination of at least two subframes with each subframe having a respective primary color. Further, the apparatus includes at least one memory device communicatively coupled to the at least one processor.

In yet another disclosed aspect, a computer program product, comprising a computer-readable medium includes code for causing a computer to receive an input color space data. The medium further includes code for causing a computer to map the received color space data to an intermediate color space. Also, the medium includes code for causing a computer to color render from the intermediate space using a pre-generated plurality of extended primary colors for temporal modulation, wherein each of the pre-generated plurality of extended primary colors comprises a combination of at least two subframes with each subframe having a respective primary color.

### BRIEF DESCRIPTION OF THE DRAWINGS

FIG. 1 illustrates an exemplary color rendering process.

FIG. 2 shows an example of color transformation from an input sRGB color data to an output device RGB color space.

FIG. 3 an exemplary pixel structure for an interferometric modulation display device.

FIG. 4 illustrates an example of color transformation from an input sRGB color data to an AIMOD output device color space.

FIG. 5 illustrates a gamut triangle with a color C falling that is to be processed within the gamut triangle.

FIG. 6 illustrates a representative color space using the presently disclosed temporal modulation to reduce color error.

FIG. 7 illustrates an exemplary method for color rendering using the above-described temporal modulation.

FIG. 8 illustrates an apparatus 800 that may be used for color rendering according to the present disclosure.

FIG. 9 illustrates an example of 3-subframe temporal modulation for generating new expanded primaries.

FIG. 10 illustrates an example of 4-subframe temporal modulation for generating new expanded primaries.

FIG. 11 shows the sampling points from White (W) to Primary (P1) to Black (K) using four sub-frames.

FIG. 12 illustrates another apparatus for color rendering operable according to the present disclosure.

### DETAILED DESCRIPTION

The present disclosure concerns methods and apparatus for color rendering in display output devices and, in particular, with devices having color constraints such as an Adjustable Interferometric Modulation Display (AIMOD) type display. The disclosed methods and apparatus employ temporal modulation to an intermediate color space having primaries that are constrained to binary values, such as in an AIMOD display. This temporal modulation engenders new primaries that are useful in reducing diffusion error for subsequent neighboring pixels yet to be rendered

Before discussing the present apparatus and methods, it is first noted at the outset that the word “exemplary” is used herein to mean “serving as an example, instance, or illustration.” Any embodiment or example denoted herein as “exemplary” is not necessarily to be construed as preferred or advantageous over other embodiments or examples.

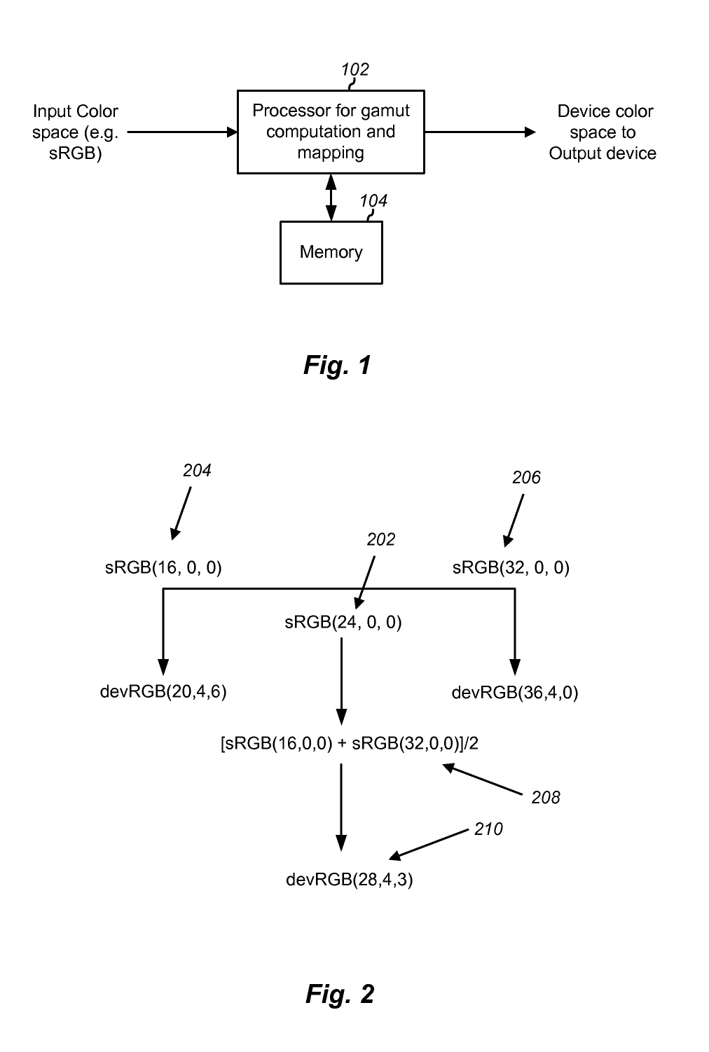

As discussed previously, the color rendering process includes mapping of the input color space to the output device color space in a manner to best optimize faithful reproduction of the input color space in the output device. As illustrated in FIG. 1, the process includes input of the source color space to a gamut mapping and computation process (or processor) 102. Process 102 includes color transformation of the input color data to the color space of the output device color space. The transformation is performed by either algorithms applied for gamut mapping, color separation, and so forth, or a more direct transformation, such as through a look-up table (LUT) stored in a memory 104 where destination color values are stored for a regular sampling of the source color space and then the destination color space data is interpolated therefrom.

FIG. 2 shows an example of color transformation from an input sRGB color data to an output device RGB color space (denoted with the nomenclature devRGB) by 3-D interpolation (as the color space is representable in 3 dimensions to provides a unique position for each color that can be created by combining three pixels (RGB)). A uniformly sampled 17×17×17 sRGB LUT conversion to the device's color space (i.e., devRGB LUT) may be pre-generated. The sampling nodes in the smaller 17×17×17 LUT may be 0, 16, 32, 48, 64, 80, 96, 112, 128, 144, . . . , 255. To convert a color that is not exactly at a node, its neighbor nodes are found and the color transformations of these neighbor nodes are used for the interpolation. For example, to transform an sRGB color, (24, 0, 0) (and shown at reference 202), to the devRGB color space, the neighbor node colors on the conversion table, (16, 0, 0) and (32, 0, 0) (shown at 204 and 206, respectively) are used. Since (24, 0, 0) is exactly in the middle of (16, 0, 0) and (32, 0, 0), a corresponding output color may be linearly interpolated by averaging the devRGB of these two neighbor nodes as shown at reference number 208 (i.e., summing the two node colors and finding the average by dividing by two). This is then translated to the device color space as shown by final value devRGB (28,4,3) (shown at 210). It is noted that this value is correlatively the average of the two translation device color values of neighbor nodes devRGB (20,4,6) and devRGB (36, 4, 0).

Although the example in FIG. 2 is a color on a linear path between two nodes, it is noted that if a color to be interpolated is on a plane instead of on a line, at least three neighbor nodes are used for interpolation. Further, if a color to be interpolated is not exactly on a plane, at least four neighbor nodes in the 3-dimensional color space would be used for volume interpolation.

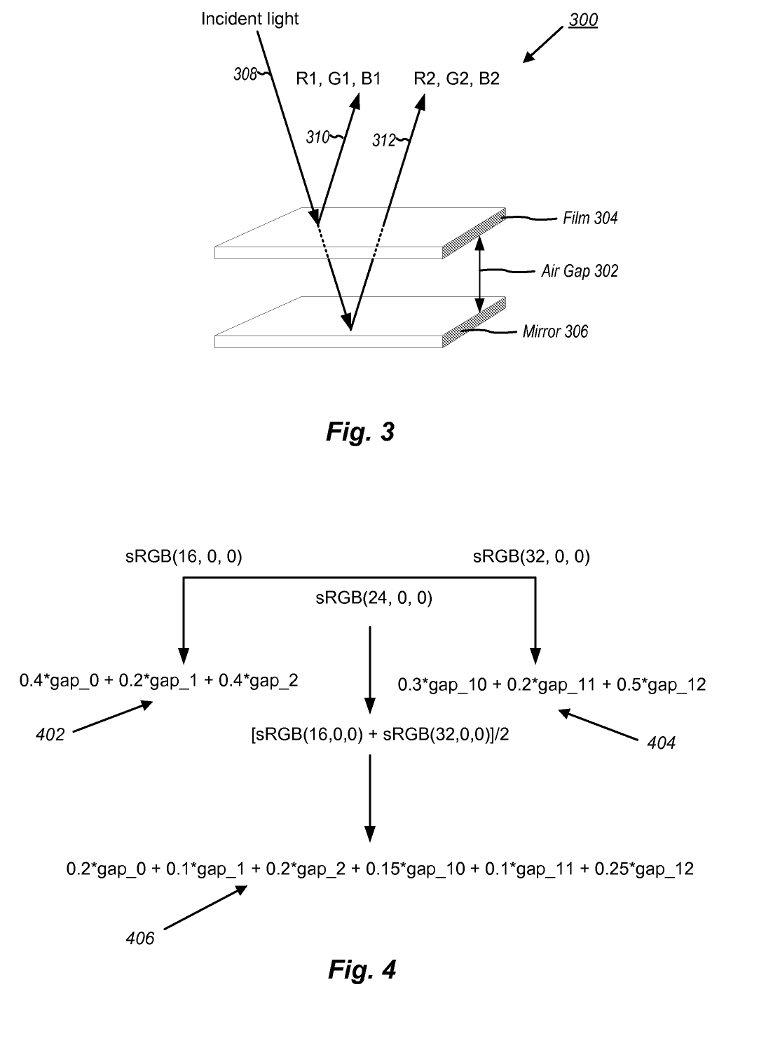

In multi-primary devices, such as an AIMOD device, such devices can produce many primary colors instead of just three (e.g., more colors than the standard Red, Green, and Blue). FIG. 3 provides a visual illustration of one pixel 300 of these types of device where an air gap distance 302 is extant between a membrane or film element 304 and a mirror device 306. When incident ambient light 308 hits the structure, it is reflected both off the top of film 304 and off the reflective mirror 306. Depending on the air gap distance 302 of the optical cavity, light of certain wavelengths reflecting off the film 304 (shown with reference 310 having wavelengths R1, G1, B1) will be slightly out of phase with the light reflecting off the mirror device 306 (shown with reference 312 having wavelengths R2, G2, B2). Based on the phase difference between 310 and 312, some wavelengths will constructively interfere, while others will destructively interfere, thus engendering a particular color to be displayed by the device. The gap distance 302 determines what primary color will be generated by the device 300. Adjustment of distance 302 affords the production of many primary colors. Additionally, it is noted that AIMOD element 300 is, at the most basic level, a binary or 1 bit device, that is, it can be driven to either a dark (black) or bright (color) state.

In order to be able to show grayscale shades or different levels of intensity of a pixel between the black and the bright states using an array of AIMOD elements, either spatial or temporal dithering can be used. Spatial dithering divides a given subpixel into many smaller addressable elements, and drives each of a plurality of individual elements (e.g., a plurality of element 300) separately in order to obtain the gray shade levels. For example, three of the elements 300 each having a respective red, green, and blue primary could be each addressed. Temporal dithering, on the other hand, works by splitting each field or frame of data into subfields or subframes with that occur in time, where some subfields last longer than the others to generate a desired intensity level with the mixture as perceived by the human optical system due to persistence of vision.

A unique primary color is thus produced by adjusting the air-gap, i.e., each primary corresponds to a respective air-gap distance. Assuming only three air gaps (i.e., three primary colors) are allowed to be used for temporal modulation with three sub-frames, a 17×17×17 sRGB LUT may be computed to convert sRGB to AIMOD device output colors. Each node of the LUT contains the fraction of modulation time of three air gaps used to produce the output color.

FIG. 4 illustrates an example of color transformation from an input sRGB color data to an AIMOD output device color space. As illustrated, an sRGB color (16, 0, 0) is produced by 0.4 of the air-gap #0, 0.2 of the air-gap #1, and 0.4 of the air-gap #2 of an AIMOD device as shown at color value 402. A neighbor sRGB node is produced with a different set of air-gaps as shown at color value 404. The interpolation result of an sRGB color, (24, 0, 0), that lies in the middle of the two nodes is the weighted average of these two nodes. The result when translated to the color space values of an AIMOD device becomes the combination of six air-gaps. When faced with a constraint that no more than three air-gaps are used to produce a color, however, this becomes problematic as two different gap values is contradictory. This demonstrates that conventional interpolation methods do not work for this type of high dimensional system.

Moreover, conventional color imaging devices are designed to have a very limited number of primary colors (typically 3 to 6 primaries) for color mixing, and any color that may be produced by mixing these primaries. If an “n” number of primaries is assumed, a color at a node of a LUT is mixed with up to n primary colors. A color that is not at a node is interpolated using the LUT and the resulting color is still the combination of up to n primary colors. As mentioned before, an AIMOD display, in which air gaps are tunable, is capable of creating a large number of primary colors. The number of primaries, n, is a very large number, and could be a few hundred, for example. However, a color to be displayed is only mixed by very few primaries. For purposes of this disclosure, the value “m” denotes the maximum number of primaries allowed to mix a color, where m is much smaller than n. Using a conventional color processing method to transform colors as shown in FIG. 3, it has been shown that the interpolation output will not meet the constraint that the number of primaries to mix colors is not larger than m.

To resolve the problem, the present methods and apparatus utilize a pre-computed LUT for color transformation that is used only for gamut mapping and transforming colors to an intermediate color space. This intermediate color space may be a device-independent uniform color space, such as CIELUV, CIELAB, or a CIECAM based color spaces, as determined by the International Commission on Illumination (CIE). Colors in the intermediate color space are then rendered by transforming the intermediate color space to the output device color space (the corresponding air-gaps) by vector error-diffusion and temporal modulation, which will be discussed below.

For purposes of explaining the present methods and apparatus, it is assumed that a source color space is sRGB, and that gamut mapping is performed in CIECAM02 JAB color space, the intermediate color space is CIELAB, and a 17×17×17 LUT is to be created to convert colors from sRGB to L*, a*, b* color space (i.e., CIELAB color space). The sRGB color gamut and the AIMOD color gamut are produced in CIECAM02 JAB color space, where each sRGB color at a node of the LUT is converted to JAB, gamut mapped to the AIMOD gamut, and then converted to LAB color space. Of course, these constraints are merely exemplary, and other color spaces or standardized color spaces are contemplated for use in the present methods and apparatus.

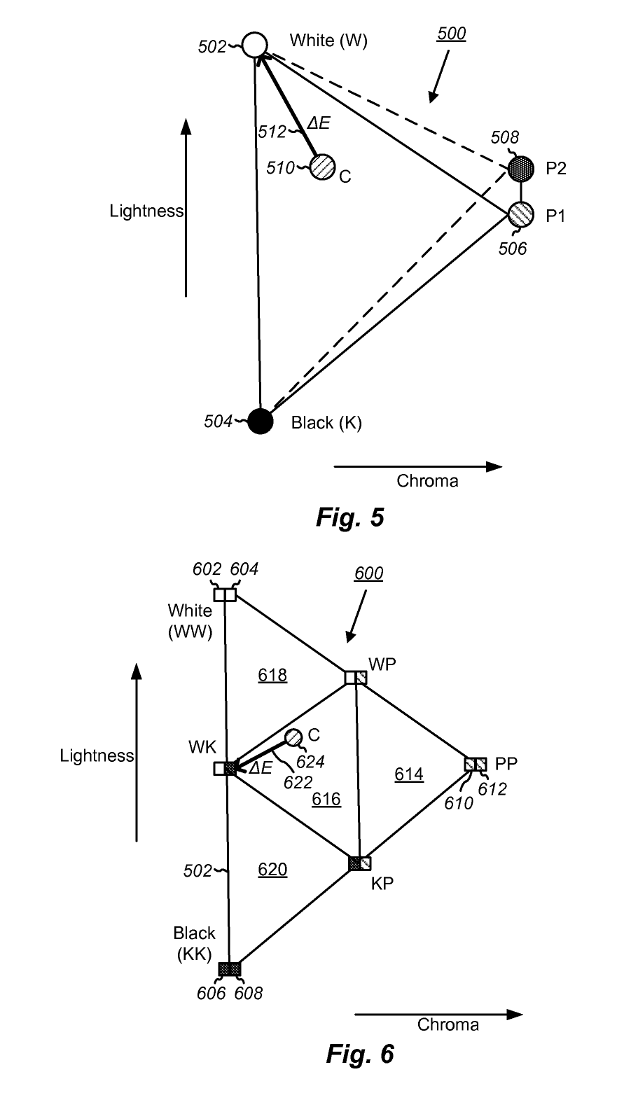

It is further noted that since AIMOD multi-primary devices, for example, produce high brightness primary colors, white and black states, the, reflective intensity of colors may be modulated by spatial dithering, involving local groups of pixels, as discussed before. An error diffusion method may be applied to determine a primary (e.g., an air-gap distance) to produce the color, and the color error is propagated to neighboring pixels that have not been dithered yet, as is known in error diffusion dithering. FIG. 5 illustrates a gamut triangle 500 wherein a color C falling within this gamut is to be processed. The color space gamut is illustrated in a graph of lightness (y direction) verses chroma (x direction). ‘White’ 502 and ‘Black’ 504 are the white and the black primaries, respectively, that lie along the lightness axis and have little chroma, and primaries P1 506 and P2 508 are two neighboring color primaries. Since the ‘White’ primary 502 is the closest color to color C 510, in this example, C 510 is mapped to the ‘White’ color 502, and a color error ΔE (512) is propagated to neighbor pixels that have not been dithered.

Because the intensity of each primary in an AIMOD display cannot be changed due to its binary nature, each triangle (e.g. 500) encompassed by the White primary, the Black primary, and a color primary P is large, and therefore the color error ΔE to be spread to neighbor pixels due to dithering can be large. This may result in unacceptable visible halftone patterns. Reducing the ΔE to be spread to other colors will reduce or eliminate the halftone artifact. This can be achieved by temporal modulation. Accordingly, by using multiple sub-frames for temporal modulation according to the present disclosure, an intermediate intensity step or color may be produced for each primary.

FIG. 6 illustrates a representative triangular color space 600 using the presently disclosed temporal modulation to reduce the color error. In an aspect, FIG. 6 illustrates color processing using a two-subframe temporal modulation that includes pre-processing primaries. Each frame for a primary color is divided into two sub-frames, and thus each based primary color is divided into two “half-primaries.” As illustrated in FIG. 6, for example, the White primary “WW” is divided into two temporal subframes 602 and 604, both being white in color. Similarly, the other primaries Black (KK) and a color primary P (PP) are divided into two subframes (606, 608, 610, 612).

Further, by mixing two half-primaries, “new” primaries are created (i.e., new in the sense of being an expanded primary mixed by temporal modulation and treated as primaries). For example, as may be seen in FIG. 6, new expanded primaries WP, KP, and WK are created by mixing two temporal subframes of White and primary P for new expanded primary WP, Black and primary P for expanded primary KP, and White and Black for expanded primary WK. The color triangle 600 encompassed by three neighbor primaries W-K-P (White, Black, and color primary P), is thus divided into four smaller triangles 614, 616, 618, 620 with the “new” temporal primaries (i.e., WK, KP, and WP), resulting in a denser sampling of the color space. Spatial dithering (error diffusion) is then performed in the denser sampled cells. Therefore, color error ΔE 622 for the color C 624 used in error diffusion to be spread to neighbor pixels becomes smaller, and the visual artifact from the spatial dithering is reduced, accordingly.

With 2-subframe temporal modulation as illustrated in FIG. 6, an n number of based primaries are expanded to n(n−1) primaries if all combinations are allowed. It is noted, however, that this increase in primaries significantly increases the computation burden of the vector error-diffusion. Thus, too large a number of mixed new primary colors may become counterproductive. Furthermore, due to the larger number of primaries in devices such as AIMOD displays, two neighbor primaries will be very close to each other in the color space. Because the color difference between White and a primary or Black and a primary is much larger than the color difference two neighbor primaries, however, larger color error ΔE from error diffusion is mostly not due to the color difference between two neighbor primaries. Since ΔE from error diffusion is mostly contributed by color difference between White and Black colors, between White and Primary colors, or between Black and Primary colors, it is recognized that mixing two neighbor primaries by temporal modulation to create a new expanded primaries, while contributing to the reduction of ΔE, the contribution is nonetheless mostly insignificant. Thus, very little improvement in reducing spatial halftoning artifacts results from mixing two neighbor primaries. According, in an aspect, it is noted that for optimizing the tradeoff of performance and reducing halftone artifacts, temporal modulation may be limited to mixing two primaries among each W-K-P triangle composed of a White primary, a Black primary, and a based color primary. With such a constraint, n based primaries are only expanded to n+2(n−2)+1=3(n−1) primaries.

According to a further aspect of the presently disclosed methodology, given a two subframe constrained temporal modulation the following conditions could be applied in an exemplary implementation:
(1) There is no color mixing (modulation) between two based color primaries (e.g., P1, P2) locations and the number of based primaries are optimized in a previous primary selection step;
(2) The three expanded primaries WK, WP, and KP as illustrated in FIG. 6 are produced by two-subframe modulation on each W-K-P plane according to the following relationships:

WK=0.5W+0.5K,

WP=0.5W+0.5P, and

KP=0.5K+0.5P; and
(3) Vector error diffusion is applied to render any color to a primary.

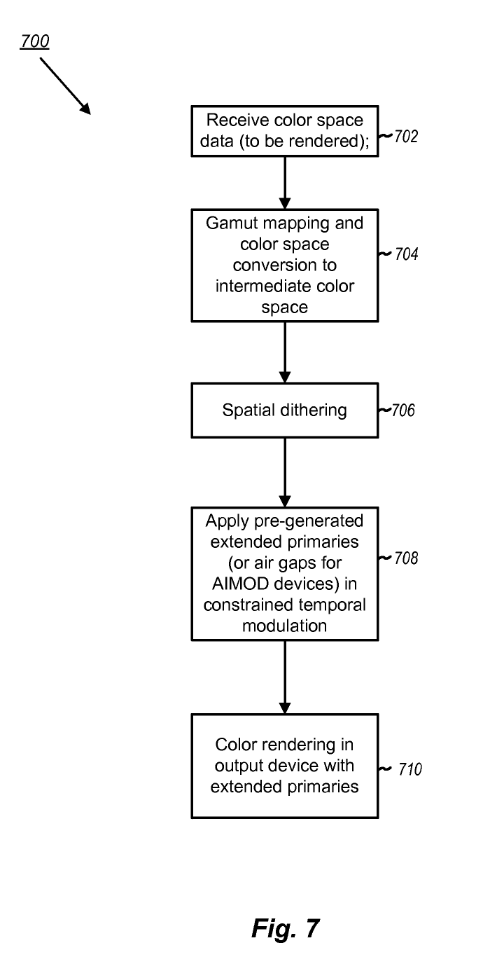

FIG. 7 illustrates an exemplary method 700 for color rendering using the above-described temporal modulation. Method 700 includes receiving an input receiving color space data (to be rendered) as shown at block 702. The input color space data may be configured to any number of formats, such as sRGB. It is also noted that the color space may be received by a processor, such as processor 102 as shown in FIG. 1, or any other processing device that may be used in color reproduction. The processing device may be within a computer, printer, mobile device, or any other device that is used to either transmit or display color data.

The received color space is gamut mapped to an intermediate, temporal color space (i.e., gamut mapping) as shown in block 704. The temporal color space may be a standardized color space, such as CIELAB, for example. Process 704 effects color space conversion from the sRGB color, for example, to an intermediate color space; e.g., a standardized CIELAB color space. The process(es) of block 704 may be implemented by a processor, such as processor 102.

From the intermediate color space created in block 704, flow proceeds to block 706 where, spatial dithering between adjacent pixels in a display device may be applied to engender varied luminance a perceived by the human eye over the space between the pixels. It is noted, that the spatial dithering may be effected through the error diffusion process. The output of this step may be physical primaries, as well as expanded primaries produced with temporal modulations.

After block 706, flow proceeds to block 708 between from the intermediate color space, color rendering may be effected from the intermediate space using the temporally modulated expanded primaries illustrated by FIG. 6. In a particular aspect, a LUT or similar construct may be used to store a pre-generated plurality of primary colors for temporal modulation, where each of the-generated plurality of primary colors comprises a combination of at least two temporal subframes with each subframe having a respective primary color as discussed with respect to FIG. 6. For example, the expanded primaries of WK, KP, and WP may be pre-generated where each of these primaries is a combination of two temporal subframes. These primaries are then used for color rendering in the output color space. By utilizing these pre-generated primaries, the computational complexity is minimized and the diffusion error ΔE from spatial dithering that is passed to neighbor pixels is reduced by providing higher color space resolution as explained previously. Additionally, in a constrained system, such as a binary AIMOD having only two states with no intensity adjustment, this temporal modulation providing expanded primaries affords better intensity control. It is noted that the process of block 708 may be carried out by a processor and memory (or database) for a LUT, or alternatively by logic circuitry and an associated memory or storage.

After the process of block 708, the determined primaries (or air gap in the case of an AIMOD) using the temporal modulation are used for color rendering in an output device's color space (e.g. devRGB) as indicated in block 710. The process in block 710 block 708 may be carried out by a processor and memory (or database) for a LUT, or alternatively by logic circuitry and an associated memory or storage.

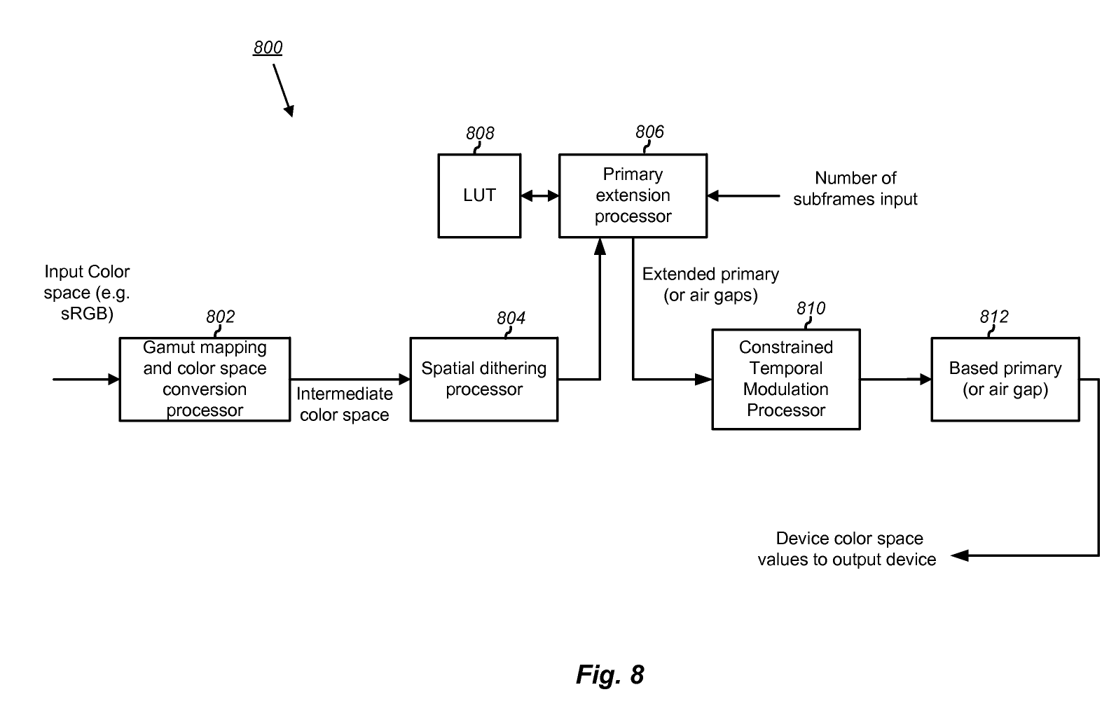

FIG. 8 illustrates an apparatus 800 that may be used for color rendering according to the present disclosure. Apparatus 800 is configured to receive an input color space data, such as sRGB data as one example. The received color data is processed by a processor 802 or similar functioning device, module, or means to gamut map and perform color space conversion to an intermediate color space. As mentioned before, the intermediate color space may consist of standardized color space that is device independent, such as CIELUV, CIELAB, or CIECAM based color spaces.

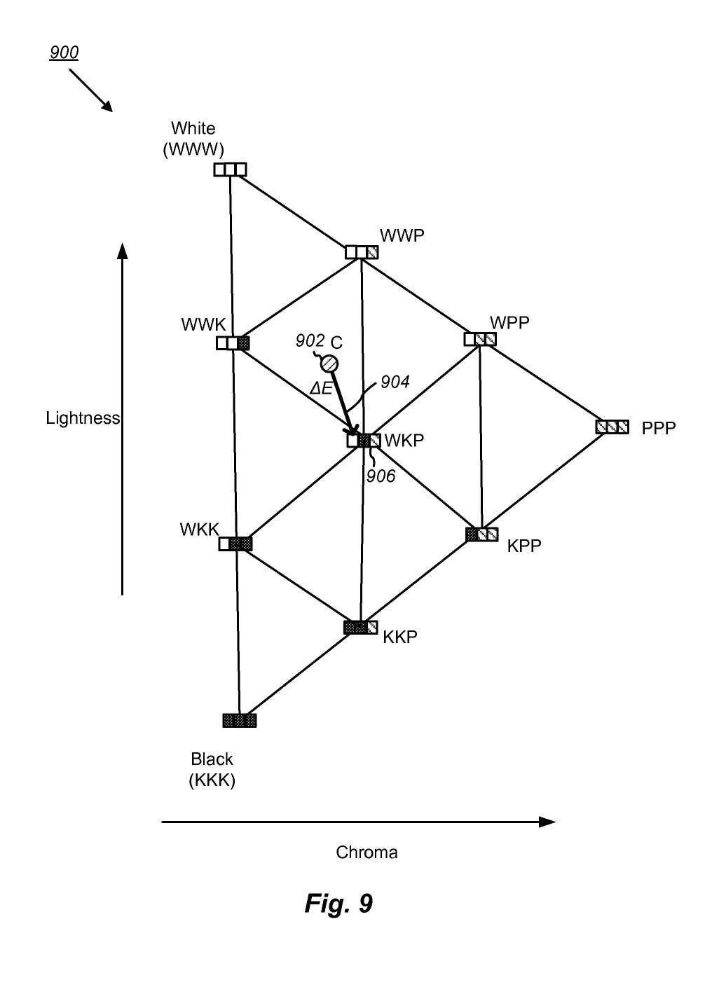

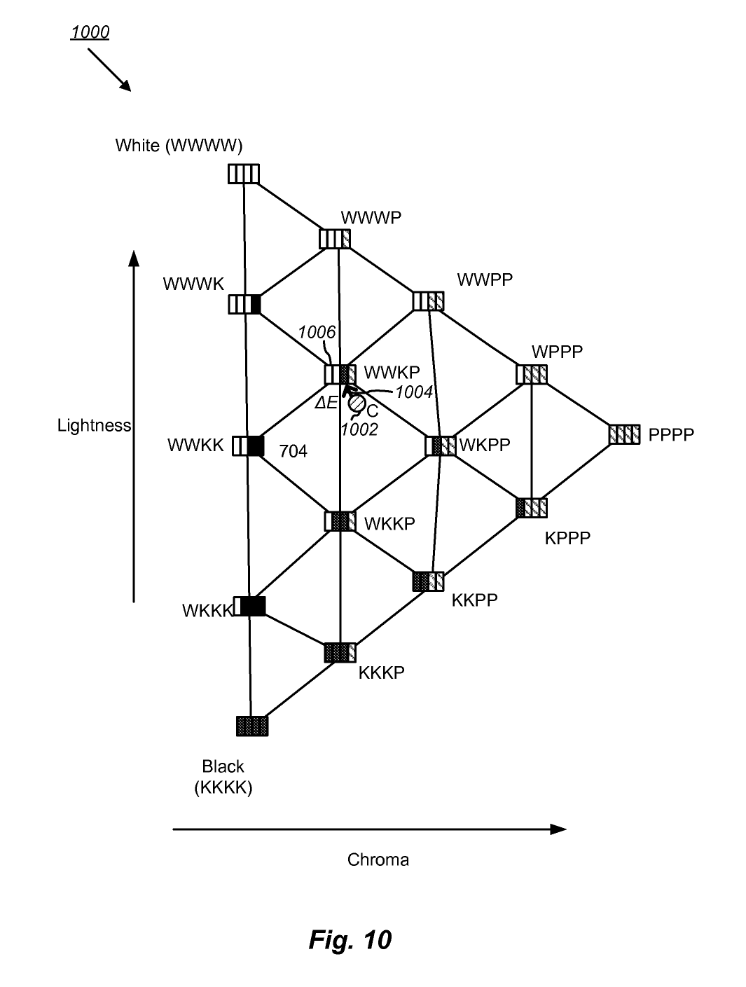

From the intermediate color space, spatial dithering by a processor 804 may be performed. Further, a processor 806 for extending the based primary colors determines temporally modulated extended primaries for use in temporal modulation. Processor 806 may utilize a LUT 808 or similar storage device or database containing pre- generated temporally modulated primaries. According to an aspect, the temporally modulated primaries are constructed using the primary colors white (W), black (K), and another primary (P). Additionally, processor 806 may be configured to receive an input of the number of subframes used for temporal modulation, such as two (2) in the example of FIG. 6. Greater numbers of subframes may be utilized to gain more extended primary colors as will be illustrated later in the examples of FIGS. 9 and 10 utilizing three (3) subframes and four (4) subframes, respectively.

The extended primary colors (or the air gaps in the case of AIMOD devices) are then used to perform temporal modulation with a processor 810. In the instance of multiple primary binary devices with constrained temporal modulation (i.e., binary states), such as with air gaps of AIMOD devices, the extended primaries using multiple subframes temporally modulated allow for different shades/intensities, while yet ensuring that no multiple contradictory air gaps will not occur, as explained before with respect to FIG. 4. Each temporally modulated primary is rendered with a set of based primaries (i.e. physical primaries) in which each based primary (e.g., W, K, P) is rendered at a temporal sub-frame by a processor 812, and then output as the device color space.

It is noted that the processing devices, modules, or means (or equivalents thereof) illustrated in FIG. 8 may be implemented by specific processors or general processors, as well as ASICs, field-programmable gate arrays (FPGAs), logic circuitry, or combinations thereof. In a mobile device, such as mobile broadband device having a display, the processing of may be further accomplished or aided by a digital signal processor (DSP) or an application processor. Furthermore, the various illustrated blocks may be implemented in one processor or at least functional portions combined to be implemented in one processor.

As mentioned above, if more sub-frames for temporal modulation can be afforded, more shades or colors will be produced. Accordingly, rules similar to 2-subframe modulation are applied for primary expansion for greater than 2 subframe modulation. As an example, FIG. 9 illustrates a gamut triangle 900 divided into smaller triangles in an example of 3-subframe modulation where seven (7) new extended primaries may be engendered, assuming that all combinations of subframes are allowed.

As an example of 3-subframe modulation, the rules would be as follows:
(1) No color mixing (modulation) between two based color primaries—location and number of based primaries are optimized in a prior primary selection step.
(2) Seven new expanded primaries are produced by 3-subframe modulation on each W-K-P plane:

WWK=(W+W+K)/3

WKK=(W+K+K)/3

WWP=(W+W+P)/3

WPP=(W+P+P)/3

KPP=(K+P+P)/3

KKP=(K+K+P)/3, and

WKP=(W+K+P)/3; and
(3) Vector error diffusion is applied to render any color to a primary.

As may be further seen in FIG. 9, when the color C (902) is to be rendered, the error distance ΔE (904) to the closest primary (e.g., WKP (906)). Thus, in this instance there is a further reduction in the diffusion error ΔE passed on to a next pixel, over the 2-subframe modulation in FIG. 6, for example.

FIG. 10 shows another gamut triangle with extended primaries utilizing 4-subframe modulation. As shown, 4-subframe temporal modulation may yield up to 12 new primaries, assuming all combinations are permitted. Similar to the rules above, rules to generate an expanded of primaries for 4-subframe temporal modulation could be as follows:
(1) No color mixing (modulation) between two primaries—number of primaries is optimized in the primary selection step;
(2) 12 new “primaries” are produced by 3-subframe modulation on each W-K-Pplane:

WWWK=(W+W+W+K)/4

WWKK=(W+W+K+K)/4

WKKK=(W+K+K+K)/4

KKKK=(K+K+K+K)/4

WWWP=(W+W+W+P)/4

WWPP=(W+W+P+P)/4

WPPP=(W+P+P+P)/4

KPPP=(K+P+P+P)/4

KKPP=(K+K+P+P)/4

KKKP=(K+K+K+P)/4

WWKP=(W+W+K+P)/4

WKKP=(W+K+K+P)/4, and

WKPP=(W+K+P+P)/4; and
(3) Vector error diffusion is applied to determine colors for modulation.

As may be further seen in FIG. 10, when the color C (1002) is to be rendered, the error distance ΔE (1004) to the closest primary (e.g., WWKP (1006)). Thus, in this example there may be a still; further reduction in the diffusion error ΔE passed on to a next pixel, over both the 2-subframe modulation in FIG. 6 and the 3-subframe modulation in FIG. 9. However, this increased resolution is more computationally complex and requires more subframes.

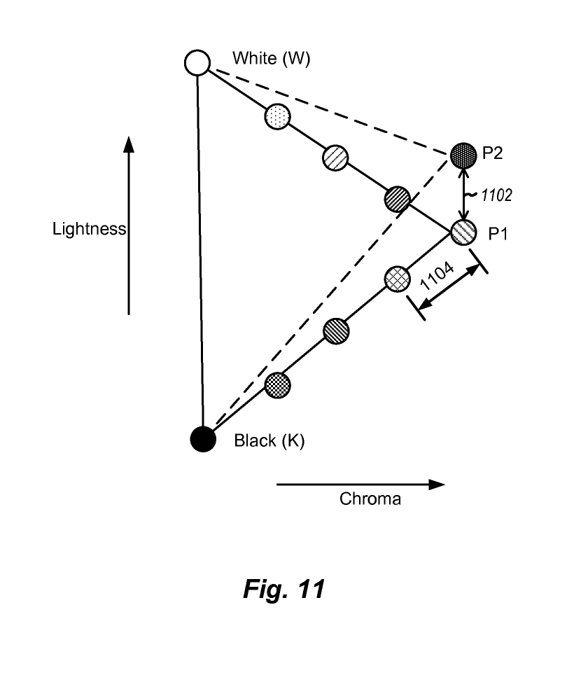

FIG. 11 shows the sampling points from White (W) to Primary (P1 or P2) to Black (K) using four sub-frames for illustration purposes. It is first noted that the disclosed constrained temporal modulation may sample the device color gamut in a uniform manner. Since the sampling density of primaries is determined by the selection of primaries, modulation between primaries is not allowed (e.g., modulation between P1 and P2 shown in FIG. 11). An ideal sampling is that the distance 1102 between two neighboring primaries (e.g., P1, P2) and the sampling distance through temporal modulation between White and a primary (P1) or between Black and the primary (P1) in a uniform color space are as equivalent as possible. Thus, the sampling density or distance 1104 between two points on the White to Primary (P1) or Black to Primary (P1) (i.e., the extended primaries) should be close to the sampling distance 1102 between two neighboring primaries P1 and P2. If more sub-frames are used, the sampling distance between two points on the White to Primary or Black to Primary would become closer, and therefore more primaries (P1, P2, etc.) should be used to shorten the distance between two neighbor points on the White or Black to primary. Conversely, if less sub-frames are used (e.g., the examples of FIG. 6 and FIG. 9), a less number of primaries may be used and the sampling distance would become greater.

It is further noted that the constrained temporal modulation can be applied to any number of various known frame rates. Ideally, the frame rate is selected to be high enough to avoid noticeable flicker.

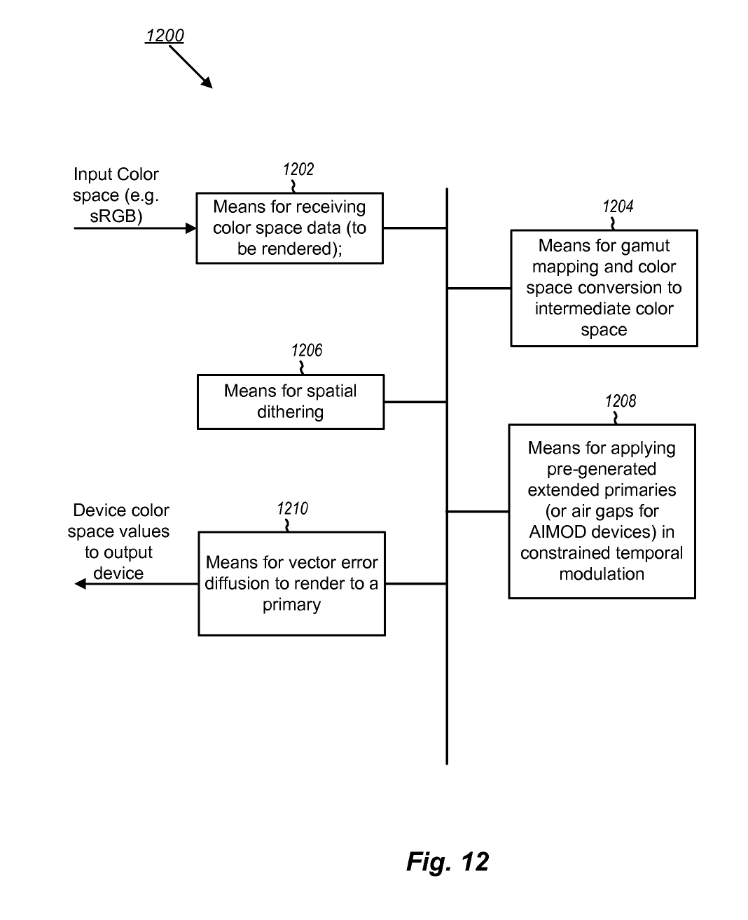

FIG. 12 illustrates another apparatus 1200 or color rendering operable according to the above-described concepts of the present disclosure. Apparatus 1200 includes means 1202 for receiving color space data that is to be rendered. The color space data may be sRGB data, as one example, and means 1202 may be implemented by a processor or equivalent device or logic circuitry. The input color space data is passed to means 1204 for gamut mapping and color space conversion to an intermediate color space, such as CIELAB for example. The intermediate color space information is then passed to means 1206 for spatial dithering. Means 1206 may be implemented by a processor or other equivalent device or logic circuitry for carrying out the function of spatial dithering.

Apparatus 1200 further includes means 1208 for applying pre-generated extended primaries (or air gaps for AIMOD devices) in constrained temporal modulation, the extended primaries being engendered with temporal subframes. Means 1208 may include a processor, as well as a storage device, such as a LUT to store the pre-generated extended primaries. Additionally, means 1208 may receive an input number of temporal subframes to be used, which affects the number and location of extended primaries to be used. In an aspect, the locations and the number of based primaries (air-gaps) for modulation and the number of sub-frames are optimized for the balance of performance and image quality. Further, apparatus 1200 includes means 1210 for vector error diffusion to render a color (e.g., color C) to a primary. In an aspect, the color is rendered to a primary through vector error diffusion.

According to the foregoing, the present apparatus and methods utilize temporal modulation for primary color expansion (i.e., new colors mixed by temporal modulation are treated as primaries). In an aspect, the colors mixed in the temporal modulation are White, Black, and a color primary to produce the new primaries. In a further aspect, for a constrained output device having binary multi-primaries, this modulation affords the ability to better modulate intensity of a color to be rendered.

It is noted that the word “exemplary” is used herein to mean “serving as an example, instance, or illustration.” Any embodiment or example described herein as “exemplary” is not necessarily to be construed as preferred or advantageous over other embodiments or examples. It is also understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, an application specific integrated circuit (ASIC), a digital signal processor (DSP), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium or computer-readable medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal The storage medium may be considered part of a “computer program product,” wherein the medium include computer codes or instructions stored therein that may cause a processor or computer to effect the various functions and methodologies described herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for color rendering comprising:
receiving color space data;
mapping the received color space data to an intermediate color space; and
color rendering from the intermediate space using a pre-generated plurality of extended primary colors for temporal modulation, wherein each of the pre-generated plurality of extended primary colors comprises a combination of at least two subframes with each subframe having a respective primary color.

2. The method as defined in claim 1, wherein the color rendering further comprises spatial dithering of the received input data.

3. The method as defined in claim 2, wherein the color rendering further comprises vector error diffusion configured to render a pixel of a particular color to a closest primary of a plurality of primaries that include the pre-generated plurality of extended primary colors.

4. The method as defined in claim 1, wherein the pre-generated plurality of primary colors are generated using at least a white primary, a black primary, and at least one other primary color.

5. The method as defined in claim 4, wherein a number of the plurality of pre-generated primary colors is determined based on an input number of desired subframe modulation.

6. The method as defined in claim 4, wherein the pre-generated plurality of primary colors are generated by at least two subframe modulation on at least one W-K-P plane comprising the white primary (W), the black primary (K) and the at least one other primary color (P).

7. The method as defined in claim 6, wherein the pre-generated plurality of primary colors for a two sub-frame modulation include one or more of a primary WK generated according to the relationship 0.5W+0.5K, a primary WP generated according to the relationship 0.5 W+0.5P, and a primary KP generated according to the relationship 0.5K+0.5P.

8. The method as defined in claim 5, wherein the pre-generated plurality of primary colors for a three sub-frame modulation include one or more of:
primary WWK generated according to the relationship (W+W+K)/3;
primary WKK generated according to the relationship (W+K+K)/3;
primary WWP generated according to the relationship (W+W+P)/3;
primary WPP generated according to the relationship (W+P+P)/3;
primary KPP generated according to the relationship (K+P+P)/3;
primary KKP generated according to the relationship (K+K+P)/3; and
primary WKP generated according to the relationship (W+K+P)/3.

9. The method as defined in claim 5, wherein the pre-generated plurality of primary colors for a four sub-frame modulation include one or more of:
primary WWWK generated according to the relationship (W+W+W+K)/4;
primary WWKK generated according to the relationship (W+W+K+K)/4;
primary WKKK generated according to the relationship (W+K+K+K)/4;
primary KKKK generated according to the relationship (K+K+K+K)/4;
primary WWWP generated according to the relationship (W+W+W+P)/4;
primary WWPP generated according to the relationship (W+W+P+P)/4;
primary WPPP generated according to the relationship (W+P+P+P)/4;
primary KPPP generated according to the relationship (K+P+P+P)/4;
primary KKPP generated according to the relationship (K+K+P+P)/4;
primary KKKP generated according to the relationship (K+K+K+P)/4;
primary WWKP generated according to the relationship (W+W+K+P)/4;
primary WKKP generated according to the relationship (W+K+K+P)/4; and
primary WKPP generated according to the relationship (W+K+P+P)/4.

10. The method as defined in claim 1, wherein the color rendering is performed for a binary high-dimensional output device.

11. The method as defined in claim 10, wherein the output device comprises an Interferometric modulation display having addressable pixel elements.

12. The method as defined in claim 1, wherein the intermediate color space comprises one of CIELUV, CIELAB, and CIECAM based color spaces.

13. An apparatus for color rendering comprising:
means for receiving color space data;
means for mapping the received color space data to an intermediate color space; and
means for color rendering from the intermediate space using a pre-generated plurality of extended primary colors for temporal modulation, wherein each of the pre-generated plurality of extended primary colors comprises a combination of at least two subframes with each subframe having a respective primary color.

14. The apparatus as defined in claim 13, wherein the color rendering further comprises means for spatial dithering of the input color space data.

15. The apparatus as defined in claim 14 wherein the color rendering further comprises vector error diffusion configured to render a pixel of a particular color to a closest primary of a plurality of primaries that include the pre-generated plurality of extended primary colors.

16. The apparatus as defined in claim 13, wherein the pre-generated plurality of primary colors are generated using at least a white primary, a black primary, and at least one other primary color.

17. The apparatus as defined in claim 16, wherein a number of the plurality of pre-generated primary colors is determined based on an input number of desired subframe modulation.

18. The apparatus as defined in claim 16, wherein the pre-generated plurality of primary colors are generated by at least two subframes modulation on at least one W-K-P plane comprising the white primary (W), the black primary (K) and the at least one other primary color (P).

19. The apparatus as defined in claim 18, wherein the pre-generated plurality of primary colors for a two sub-frame modulation include one or more of a primary WK generated according to the relationship 0.5 W+0.5 K, a primary WP generated according to the relationship 0.5 W+0.5 P, and a primary KP generated according to the relationship 0.5 K+0.5 P.

20. The apparatus as defined in claim 18, wherein the pre-generated plurality of primary colors for a three sub-frame modulation include one or more of:
primary WWK generated according to the relationship (W+W+K)/3;
primary WKK generated according to the relationship (W+K+K)/3;
primary WWP generated according to the relationship (W+W+P)/3;
primary WPP generated according to the relationship (W+P+P)/3;
primary KPP generated according to the relationship (K+P+P)/3;
primary KKP generated according to the relationship (K+K+P)/3; and
primary WKP generated according to the relationship (W+K+P)/3.

21. The apparatus as defined in claim 18, wherein the pre-generated plurality of primary colors for a four sub-frame modulation include one or more of:
primary WWWK generated according to the relationship (W+W+W+K)/4;
primary WWKK generated according to the relationship (W+W+K+K)/4;
primary WKKK generated according to the relationship (W+K+K+K)/4;
primary KKKK generated according to the relationship (K+K+K+K)/4;
primary WWWP generated according to the relationship (W+W+W+P)/4;
primary WWPP generated according to the relationship (W+W+P+P)/4;
primary WPPP generated according to the relationship (W+P+P+P)4;
primary KPPP generated according to the relationship (K+P+P+P)/4;
primary KKPP generated according to the relationship (K+K+P+P)/4;
primary KKKP generated according to the relationship (K+K+K+P)/4;
primary WWKP generated according to the relationship (W+W+K+P)/4;
primary WKKP generated according to the relationship (W+K+K+P)/4; and
primary WKPP generated according to the relationship (W+K+P+P)/4.

22. The apparatus as defined in claim 13, wherein the apparatus is used for color rendering in a binary high-dimensional output device.

23. The apparatus as defined in claim 22, wherein the output device comprises an Interferometric modulation display having addressable pixel elements.

24. The apparatus as defined in claim 13, wherein the intermediate color space comprises one of CIELUV, CIELAB, and CIECAM based color spaces.

25. An apparatus for color rendering comprising:
at least one processor configured to:
receive color space data;
map the received color space data to an intermediate color space; and
color render from the intermediate space using a pre-generated plurality of extended primary colors for temporal modulation, wherein each of the pre-generated plurality of extended primary colors comprises a combination of at least two subframes with each subframe having a respective primary color; and
at least one memory device communicatively coupled to the at least one processor.

26. The apparatus as defined in claim 25, wherein the color rendering further comprises means for spatial dithering of the input color space data.

27. The apparatus as defined in claim 25, wherein the color rendering further comprises vector error diffusion configured to render a pixel of a particular color to a closest primary of a plurality of primaries that include the pre-generated plurality of extended primary colors.

28. The apparatus as defined in claim 25, wherein the pre-generated plurality of primary colors are generated using at least a white primary, a black primary, and at least one other primary color.

29. The apparatus as defined in claim 28, wherein a number of the plurality of pre-generated primary colors is determined based on an input number of desired subframe modulation.

30. The apparatus as defined in claim 28, wherein the pre-generated plurality of primary colors are generated by at least two subframes modulation on at least one W-K- P plane comprising the white primary (W), the black primary (K) and the at least one other primary color (P).

31. The apparatus as defined in claim 30, wherein the pre-generated plurality of primary colors for a two sub-frame modulation include one or more of a primary WK generated according to the relationship 0.5W+0.5K, a primary WP generated according to the relationship 0.5W+0.5P, and a primary KP generated according to the relationship 0.5K+0.5P.

32. The apparatus as defined in claim 30, wherein the pre-generated plurality of primary colors for a three sub-frame modulation include one or more of:
primary WWK generated according to the relationship (W+W+K)/3;
primary WKK generated according to the relationship (W+K+K)/3;
primary WWP generated according to the relationship (W+W+P)/3;
primary WPP generated according to the relationship (W+P+P)/3;
primary KPP generated according to the relationship (K+P+P)/3;
primary KKP generated according to the relationship (K+K+P)/3; and
primary WKP generated according to the relationship (W+K+P)3.

33. The apparatus as defined in claim 30, wherein the pre-generated plurality of primary colors for a four sub-frame modulation include one or more of:
primary WWWK generated according to the relationship (W+W+W+K)/4;
primary WWKK generated according to the relationship (W+W+K+K)/4;
primary WKKK generated according to the relationship (W+K+K+K)/4;
primary KKKK generated according to the relationship (K+K+K+K)/4;
primary WWWP generated according to the relationship (W+W+W+P)/4;
primary WWPP generated according to the relationship (W+W+P+P)/4;
primary WPPP generated according to the relationship (W+P+P+P)/4;
primary KPPP generated according to the relationship (K+P+P+P)/4;
primary KKPP generated according to the relationship (K+K+P+P)/4;
primary KKKP generated according to the relationship (K+K+K+P)/4;
primary WWKP generated according to the relationship (W+W+K+P)/4;
primary WKKP generated according to the relationship (W+K+K+P)/4; and
primary WKPP generated according to the relationship (W+K+P+P)/4.

34. The apparatus as defined in claim 25, wherein the apparatus is used for color rendering in a binary high-dimensional output device.

35. The apparatus as defined in claim 34, wherein the output device comprises an Interferometric modulation display having addressable pixel elements.

36. The apparatus as defined in claim 25, wherein the intermediate color space comprises one of CIELUV, CIELAB, and CIECAM based color spaces.

37. A computer program product, comprising:
computer-readable medium comprising:
code for causing a computer to receive an input color space data;
code for causing a computer to map the received color space data to an intermediate color space; and
code for causing a computer to perform color rendering from the intermediate space using a pre-generated plurality of extended primary colors for temporal modulation, wherein each of the pre-generated plurality of extended primary colors comprises a combination of at least two subframes with each subframe having a respective primary color.

38. The computer program product as defined in claim 37, wherein the color rendering further comprises means for spatial dithering of the input color space data.

39. The computer program product as defined in claim 38, wherein the color rendering further comprises vector error diffusion configured to render a pixel of a particular color to a closest primary of a plurality of primaries that include the pre-generated plurality of extended primary colors.

40. The computer program product as defined in claim 37, wherein the pre-generated plurality of primary colors are generated using at least a white primary, a black primary, and at least one other primary color.

41. The computer program product as defined in claim 40, wherein a number of the plurality of pre-generated primary colors is determined based on an input number of desired subframe modulation.

42. The computer program product as defined in claim 40, wherein the pre-generated plurality of primary colors are generated by at least two subframes modulation on at least one W-K-P plane comprising the white primary (W), the black primary (K) and the at least one other primary color (P).

43. The computer program product as defined in claim 42, wherein the pre-generated plurality of primary colors for a two sub-frame modulation include one or more of a primary WK generated according to the relationship 0.5W+0.5K, a primary WP generated according to the relationship 0.5W+0.5P, and a primary KP generated according to the relationship 0.5K+0.5P.

44. The computer program product as defined in claim 42, wherein the pre-generated plurality of primary colors for a three sub-frame modulation include one or more of:
primary WWK generated according to the relationship (W+W+K)/3;
primary WKK generated according to the relationship (W+K+K)/3;
primary WWP generated according to the relationship (W+W+P)/3;
primary WPP generated according to the relationship (W+P+P)/3;
primary KPP generated according to the relationship (K+P+P)/3;
primary KKP generated according to the relationship (K+K+P)/3; and primary WKP generated according to the relationship (W+K+P)/3.

45. The computer program product as defined in claim 42, wherein the pre-generated plurality of primary colors for a four sub-frame modulation include one or more of:
primary WWWK generated according to the relationship (W+W+W+K)/4;
primary WWKK generated according to the relationship (W+W+K+K)/4;
primary WKKK generated according to the relationship (W+K+K+K)/4;
primary KKKK generated according to the relationship (K+K+K+K)/4;
primary WWWP generated according to the relationship (W+W+W+P)/4;
primary WWPP generated according to the relationship (W+W+P+P)/4;
primary WPPP generated according to the relationship (W+P+P+P)/4;
primary KPPP generated according to the relationship (K+P+P+P)/4;
primary KKPP generated according to the relationship (K+K+P+P)/4;
primary KKKP generated according to the relationship (K+K+K+P)/4;
primary WWKP generated according to the relationship (W+W+K+P)/4;
primary WKKP generated according to the relationship (W+K+K+P)/4; and
primary WKPP generated according to the relationship (W+K+P+P)/4.

46. The computer program product as defined in claim 37, wherein the apparatus is used for color rendering in a binary high-dimensional output device.

47. The computer program product as defined in claim 46, wherein the output device comprises an Interferometric modulation display having addressable pixel elements.

48. The computer program product as defined in claim 37, wherein the intermediate color space comprises one of CIELUV, CIELAB, and CIECAM based color spaces.
